(19) United States
(12) Patent Application Publication
(10) Pub. No.: US 2006/0084438 A1
(43) Pub. Date: Apr. 20, 2006

(54) Method and system for controlling hard handoff in mobile network

(75) Inventor: Jae-Yeong Kwon, Suwon-Si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/242,932

(22) Filed: Oct. 5, 2005

(30) Foreign Application Priority Data
Oct. 5, 2004 (KR) 10-2004-0079278

(51) Int. Cl. H04Q 7/20

(52) U.S. Cl. 455/436

(57) ABSTRACT

A method and system for controlling an inter-mobile switching center hard handoff in a mobile network are provided. The method includes recognizing, at a terminal, a target cell whose pilot strength is equal to or higher than a candidate qualification reference value and transmitting a pilot strength measurement message to a base station. A pilot measurement request order message and the pilot strength measurement message are exchanged between the terminal and the base station even within a handoff restricted time and it is determining whether or not to perform the handoff. A handoff order is transmitted from the base station to the terminal ordering a handoff to the target cell, in the case that the difference in pilot signal strength between the serving cell and the target cell exceeds the active interval value after the handoff restricted time has lapsed.

### CLAIM OF PRIORITY

This application makes reference to, incorporates the entire content of the same herein, and claims all benefits accruing under 35 U.S.C. §119(a) from an application for METHOD AND SYSTEM FOR CONTROLLING HARD HANDOFF IN MOBILE NETWORK filed in the Korean Intellectual Property Office on Oct. 5, 2004 and there duly assigned Serial No. 2004-79278.

### BACKGROUND OF THE INVENTION

1. Field of the Invention

The present invention relates to a handoff in a mobile communication system. More particularly, the present invention relates to a method and system for controlling an inter-mobile switching center hard handoff in a mobile network so as to minimize reduction in call quality due to call discontinuation, a drop in handoff success rate, and a ping-pong phenomenon caused by performing the inter-mobile switching center hard handoff, and thus ultimately improve mobile communication service call quality.

2. Description of the Related Art

The most common example of a mobile network is a Code Divisional Multiple Access (CDMA) system, wherein service regions are divided into small areas referred to as cells and the same frequency is reused in different cells in order to make efficient use of frequency resources. Since the service region is divided into cells, when a mobile terminal moves to another cell, it begins to communicate with a new base station managing that cell, which is referred to as a “handoff”.

When the mobile terminal is in a handoff mode, it performs the handoff while communicating with one or more base stations simultaneously before performing a handoff from a current base station to a neighboring base station, which is referred to “soft handoff”. The soft handoff is characterized in that communication with a neighboring base station begins before communication with a current base station is terminated, which is referred to as “make before break”. There is a modified version of the soft handoff called a softer handoff, wherein the mobile terminal simultaneously communicates with a plurality of sectors within the same base station.

Since the soft handoff reduces call disconnection and interruption while performing the handoff, increases the gain of a downlink signal-to-noise ratio, and prevents simultaneous occurrence of average fading and convergence from a multi-path effect, there are many advantages such as reducing the effects of log normal and multi-path fading.

Another form of handoff occurring in the CDMA system is a “hard handoff”, which is performed between two frequencies or when a base station is not suitably synchronized for the soft handoff. Such form of handoff is characterized in that communication on a first frequency is broken before communication on a second frequency is established, which is referred to as “break before make”.

A hard handoff occurring in the same cell is referred to an intra-cell hard handoff, and a hard handoff occurring between cells is referred to an inter-cell hard handoff. Further, a hard handoff occurring between mobile switching centers is referred to an inter-MSC hard handoff.

In a Korean mobile communication system, an inter-MSC handoff is sometimes performed as an inter-MSC soft handoff using a router.

In an inter-MSC soft handoff using a router, the terminal performs the handoff while maintaining both cells (a serving cell and a target cell) as an active set in the same manner as a general soft handoff, so that disconnection does not occur, unlike the hard handoff, and the handoff success rate is excellent like the general handoff.

However, in the inter-MSC hard handoff without the router, there is a high disconnection rate since a serving cell and a target cell are not simultaneously maintained as an active set as in the soft handoff, and cell occupation status of the terminal is suddenly transferred from the serving cell to the target cell.

First, some general information needed to understand the handoff will be provided.

When considering a handoff, the terminal is processed by divided pilot pseudo random noise (PN) to be received into an active set, a candidate set, a neighbor set, and a remaining set.

The active set is a channel assigned to a forward traffic channel, and the candidate set has a pilot pseudo random noise (PN) signal with sufficient electric field strength even though it is not included into the active set. Further, the neighbor set includes a sufficiently strong pilot PN to be a candidate set for the handoff, and the remaining set includes other pilot PNs received in the terminal.

A standard for sorting the pilot sets uses parameters such as T_ADD where the neighbor set becomes the candidate set, a timer T_TDROP operating in the event of a drop below a reference point T_DROP in the active set, and a reference value to be compared with the active set.

Such pilot set sorting is defined on the basis of an Ec/Io (signal-to-noise ratio) value received from a searcher of the terminal. Terminals based on Qualcomm Inc. measure received electric field strength using the Ec/Io value and indicate the result on a terminal display.

A procedure for performing the inter-MSC hard handoff using the above parameters is as follows.

FIG. 1 is a flowchart of a conventional inter-MSC hard handoff procedure.

The mobile terminal moves to a target cell (S11), senses a pilot PN whose value is higher than the T_ADD value (S12), and transmits a pilot strength measurement message (PSMM) to the base station (S13). Here, the base station is defined to include a base transceiver station (BTS) and a base station controller (BSC). The base station which has received the PSMM determines whether or not a difference between an Ec/Io value of a target cell on the PSMM reported by the terminal and an Ec/Io of the serving cell exceeds T_COMP (S14). Here, Ec/Io is the ratio of pilot energy (Ec) accumulated during a pseudo noise chip period to total power spectrum density (Io) within the received bandwidth.

When the pilot signal strength of the target cell exceeds the pilot signal strength of the serving cell by a predetermined level, the base station transmits a handoff direction message (HDM) to the mobile terminal indicating that a handoff is to be performed to the target cell (S15).

The reason why the handoff direction message is used is that while a channel assignment message controls the active set during an idle state in the system, the handoff direction message controls the active set during a traffic state.

The terminal that has received the HDM transmits a handoff completion message (HCM) to the target cell in order to perform the handoff to the target cell (S16). The base station transmits an in-traffic system parameter message, a power control message, and a neighbor list update message to the terminal in order to inform the terminal of new system information (S17).

However, a problem occurs when the handoff process is performed using the above-described method.

While basic information used by the system to process an IMHHO is the PSMM of the terminal, one of the following three conditions should be satisfied in order for the terminal to transmit the PSMM to the system:

First, the Ec/Io of the target cell exceeds the T_ADD;

Second, the difference between the Eo/Io of the target cell and the Ec/Io of the serving cell exceeds the T_DROP value; and

Third, the Ec/Io of the serving cell drops below the T_DROP value and the T_TDROP has expired.

If none of the three conditions is satisfied, the terminal does not report the PSMM and the system does not perform the handoff.

Further, in the case of the hard handoff, a specified restricted time Guard_Time (handoff restricted time) is established in order to prevent a ping-pong phenomenon. That is, Guard_Time is established to prevent a handoff back to the serving cell after a handoff to the target cell. The system does not perform a handoff within the Guard_Time even when the terminal reports a PSMM that meets the T_COMP condition for a hard handoff.

In such a state of refraining from performing a handoff, at a point of time when a signal of the serving cell drops below T_DROP and T_TDROP has expired, the terminal reports the PSMM to the system and the system performs the hard handoff to the target cell. However, since the signal of the serving cell deteriorates in a radio environment below the T_DROP, a call drop in the hard handoff occurs due to signal processing error between the terminal and the base station inevitably occurs, which considerably reduces service quality of the inter-MSC hard handoff.

### SUMMARY OF THE INVENTION

It is an objective of the present invention to provide a method and system for controlling a hard handoff in a mobile network, capable of providing a more stable inter-mobile switching center hard handoff by making changes in a handoff mechanism with which a ping-pong phenomenon between a serving cell and a target cell is prevented when performing the inter-mobile switching center hard handoff.

According to an aspect to the present invention, there is provided a method for controlling a handoff in a mobile network. The method includes recognizing, at a terminal, a target cell whose pilot strength is equal to or higher than a candidate qualification reference value and transmitting a pilot strength measurement message to a base station. A pilot measurement request order message and the pilot strength measurement message are exchanged between the terminal and the base station even within a handoff restricted time and a determination is made whether or not to perform the handoff.

The method of the present invention may further comprise transmitting, at the base station, a handoff order to the terminal ordering a handoff to the target cell, in the case that the difference in pilot signal strength between the serving cell and the target cell exceeds the active interval value after the handoff restricted time has lapsed.

The method of the present invention may further comprise performing, at the terminal, the handoff to the target cell upon receipt of the handoff order, and transmitting to the base station a handoff completion message indicating that the handoff has been completed.

The method of the present invention may further comprise providing the terminal with the message including (needed) information on the target cell needed after completing the handoff.

The base station may not perform the handoff until the handoff restricted time lapses, even when a difference in pilot signal strength between a serving cell and a target cell exceeds an active interval value. The base station also preferably periodically transmits a pilot measurement request order message to the terminal without performing the handoff within the handoff restricted time.

The terminal regularly may receive the pilot measurement request order from the base station, and provide the base station with pilot signal information contained therein whose strength exceeds a predetermined value. The pilot signal information is preferably transmitted through the pilot strength measurement message.

The base station preferably stops transmitting the pilot measurement request order message to the terminal when a signal-to-noise ratio of the target cell is equal to or less than a drop timer operation reference value, and resumes transmission the pilot measurement request order message upon receipt of a pilot strength measurement message in which a signal-to-noise ratio of a target cell exceeds the candidate qualification reference value.

According to another aspect of the present invention, there is provided a system for controlling a handoff in a mobile network. The system comprises a terminal located adjacent to a serving cell and a target cell that are controlled by different mobile switching centers. The terminal recognizes a target cell whose pilot strength is higher than a candidate qualification reference value and transmits a pilot strength measurement message over a wireless network in order to attempt a handoff from the serving cell to the target cell. A base station receives pilot strength information from the terminal and periodically transmits a pilot measurement request order message to the terminal, thereby determining whether or not an inter-mobile switching center hard handoff has been performed.

The base station preferably periodically transmits a pilot measurement request order message to the terminal without performing the handoff within a handoff restricted time, even when it is recognized that a difference in pilot strength between the target cell and the serving cell reported from the terminal exceeds an active interval value.

The mobile terminal periodically preferably responds to the pilot measurement request order message received from the base station with the pilot strength measurement message without performing the handoff within the handoff restricted time.

According to yet another aspect of the present invention, there is provided a mobile terminal located within a mobile network and performing an inter-mobile switching center hard handoff between a serving cell and a target cell belonging to different mobile switching centers. The mobile terminal recognizes a target cell whose pilot strength is higher than a candidate qualification reference value, transmits a pilot strength measurement message to a base transceiver station, reports a pilot strength measurement message responsive to a pilot measurement request order message periodically received from the base transceiver station within a handoff restricted time to the base transceiver station, and compares a pilot strength of the serving cell with that of the target cell to determine whether or not to perform the handoff.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1 is a flowchart of a conventional inter-MSC hard handoff procedure;

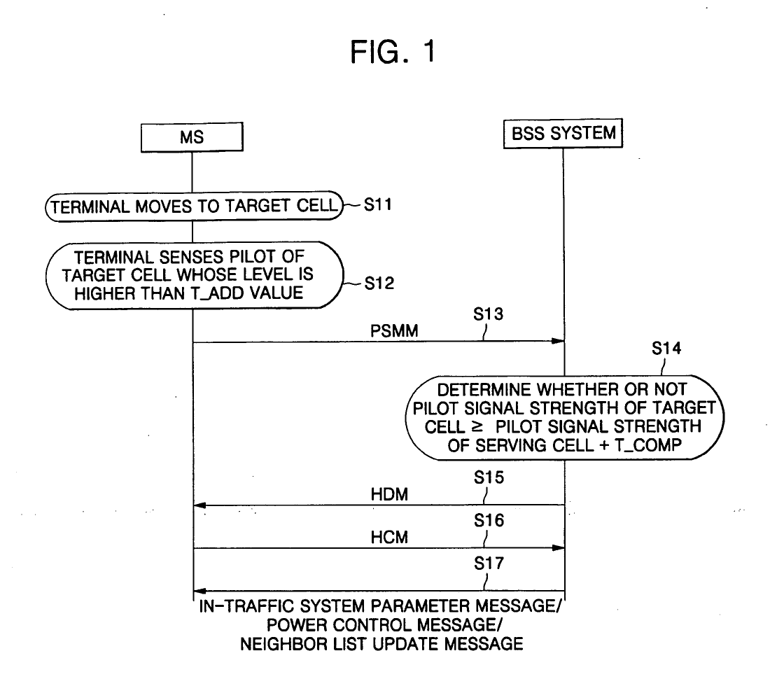

FIG. 2 illustrates a configuration of a CDMA mobile communication system according to an embodiment of the present invention; and

FIG. 3 is a flowchart of an inter-mobile switching center hard handoff process in accordance with an embodiment of the present invention.

Throughout the drawings like reference numbers should be understood to refer to like elements, features and structures.

### DETAILED DESCRIPTION OF EXEMPLARY EMBODIMENTS

Hereinafter, exemplary embodiments of the present invention will be described more fully with reference to the accompanying drawings. While the exemplary embodiments of the present invention will be generally described in connection with a CDMA system, the present invention is not so limited, and those of ordinary skill in the art will readily appreciate that the invention can be applied to communication systems other than CDMA systems. In particular, embodiments of the present invention can also be applied to a GSM, OFDMA, wireless Internet, and other mobile networks.

An embodiment of the present invention can be realized by adding a new call flow while accepting a call flow in a conventional inter-mobile switching center hard handoff. That is, in order to solve the problem of a mobile terminal ceasing to transmit a PSMM when it reports a PSMM which meets an active interval (T_COMP) condition within a handoff restricted time (Guard_Time), embodiments of the present invention use a pilot measurement request order (PMRO) message.

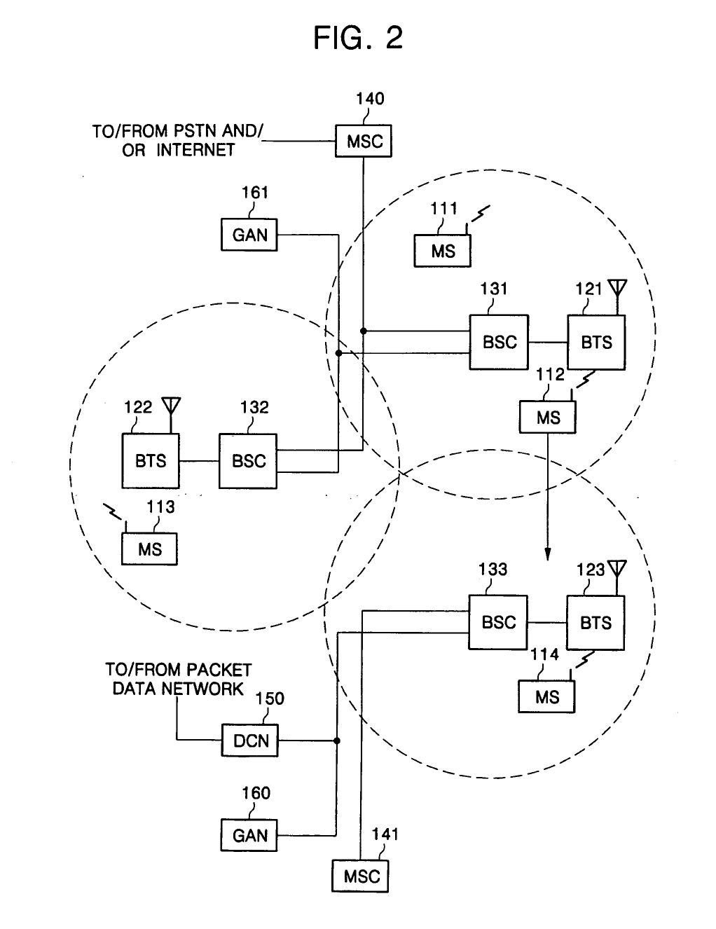

FIG. 2 illustrates a configuration of a CDMA mobile communication system according to an embodiment of the present invention.

The CDMA mobile communication system includes a plurality of cell sites each of which is the coverage of a base transceiver station. Base transceiver stations 121, 122 and 123 communicate with a plurality of mobile terminals 111, 112, 113 and 114. The mobile terminals 111, 112, 113 and 114 may be any suitable wireless communication device such as a conventional cellular phone, a personal communication system (PCS) handset device, a handheld computer, a remote measurement device, and the like. The devices can communicate with the base transceiver stations via a wireless link. Further, the wireless communication system may include other forms of access terminals including fixed access terminals. FIG. 2 shows mobile terminals only.

Referring to FIG. 2, dotted lines show boundaries of cell sites in which base stations are located. While cell sites are usually shown as circles, they may have other irregular shapes according to a selected cell configuration and natural or artificial obstacles. Here, each base station is defined to include a base station controller and a base transceiver station combined with the base station controller.

Base station controllers 131, 132 and 133 are devices for managing wireless communication resources including the base transceiver station with respect to specified cells in the wireless communication network. The base transceiver stations 121, 122 and 123 include a wireless transceiver, an antenna, and other electronics mounted on each cell site. Such electronics include an air conditioner device, a heater, a power source, a telephone line interface, an RF transmitter, and an RF receiver.

The base stations communicate with other base stations via a communication line and a mobile switching center (MSC), and transmit voice and data signals over public switched telephone networks. The mobile switching center 140 is a switching device for providing service and control between a wireless network such as a public switched telephone network or the Internet and subscribers of external networks. The communication line links each vocoder in the base station controller to switch devices in the mobile switching center.

Each link provides a digital path for transmitting voice signals in a pulse code modulation format. The communication line may be any suitable connection means including a T1 line, a T3 line, an optical fiber link, and a network backbone connection, or different data links, wherein each data link combines a base station with the mobile switching center.

The base station transfers data signals between the communication line and the data communication network (DCN) 150 server through the communication line and data core network server, and between the communication line and the Internet or some other packet data network. The data communication network 150 server is a packet data switching and routing device providing service between a wireless network such as a company Ethernet system or the Internet and subscribers of external packet data networks. The communication line may be any connection line including an Ethernet link, a T1 connection, a T3 line, an optical fiber link, a network backbone connection, and may include different data links. Here, each data link couples one of the base stations to the data communication network server.

General ATM switch networks (GANs) 160 and 161 are combined with a plurality of base station controllers, and maintenance for a plurality of base station controllers and a plurality of base transceiver stations can be performed through GANs 160 and 161. That is, the GAN operates as an asynchronous transfer mode (ATM) switch for a base station controller.

When an IMSHO router (not shown) is connected to a plurality of GANs, it is possible to perform an inter-mobile switching center soft handoff. Embodiments of the present invention are concerned with improving a hard handoff in the case that there is no inter-mobile switching center soft handoff router, that is, in the case that only inter-mobile switching center hard handoff is performed.

In a wireless network, the mobile terminal is located in a cell site to communicate with the base station, or is located in a cell site which is close to another cell site. A directional arrow sign adjacent to the mobile terminal 112 indicates that the mobile terminal moves to a target cell site. As the mobile terminal moves to the target cell site from a serving cell site a handoff occurs.

The handoff process is performed by transferring cell control from a first cell (serving cell) to a second cell (target cell). The handoff includes a soft handoff and a hard handoff. The soft handoff is characterized in that before an existing connection between the mobile terminal and the base station in the first cell is released, another connection between the mobile terminal and the base station in the second cell is established. The hard handoff is characterized in that before a new connection between the mobile terminal and the base station in the second cell is established, the existing connection between the mobile terminal and the base station in the first cell is released.

The inter-mobile switching center hard handoff process is described on the basis of the system configuration of FIG. 2 centering on the mobile switching center.

A providing base station controller 131 transmits information including a mobile switching center ID and a cell ID to a providing mobile switching center 140 through a handoff request message. The providing mobile switching center 140 performs a trunk assignment request when it receives a handoff request message. The providing mobile switching center 140 transmits information including a Trunk Group Number (TGN), a Trunk Member Number (TMN), and a cell ID through a resource assignment message. When the target mobile switching center 141 receives the resource assignment request message, it transmits information including the cell ID to a target base station controller 133 through the base transceiver center resource assignment message.

The target base station controller 133 transmits data including wireless channel information to the target mobile switching center 141 through a base transceiver center resource assignment response message. Subsequently, the target mobile switching center 141 performs the trunk assignment process and a switch connection process in a target system. The target mobile switching center 141 transmits data including wireless channel information to the providing mobile switching center 140 through a resource assignment request message for assignment, and the providing mobile switching center 140 performs a call path connection process between an opponent subscriber and a trunk line. When the providing mobile switching center 140 transmits a handoff performance order message to the target base station 133, the target base station controller 133 transmits a handoff completion message to the target mobile switching center 141, and the target mobile switching center 141 transmits the handoff completion report message to the providing mobile switching center 140. Although FIG. 2 does not illustrate a connection between the providing mobile switching center and the target mobile switching center, they are combined one-to-one or in a centralized fashion on the basis of a connection medium.

The inter-mobile switching center hard handoff process has been described above in connection with the operation of the mobile switching center and will be described below in reference to the base station and mobile terminal.

It is assumed that the mobile terminals communicate with the base station on a CDMA channel in the CDMA system. As the mobile station moves from one cell to another cell, the mobile terminal determines that the handoff is requested on the basis of detection of a control signal from the base station, an increased bit error rate in a signal from the base station, a signal time delay, or some other property.

When the strength of the control signal is transmitted by the base station, a bit error rate of the signal is received from the base station, or a round trip time delay exceeds a threshold value, the base station initiates a handoff process by the mobile terminal requiring the handoff and the target base transceiver station. The base station and the mobile terminal start to negotiate establishment of a communication link. Accordingly, a call is transferred from one base station to another base station.

An inter-mobile switching center hard handoff method in accordance with an exemplary embodiment of the present invention will be described in greater detail below.

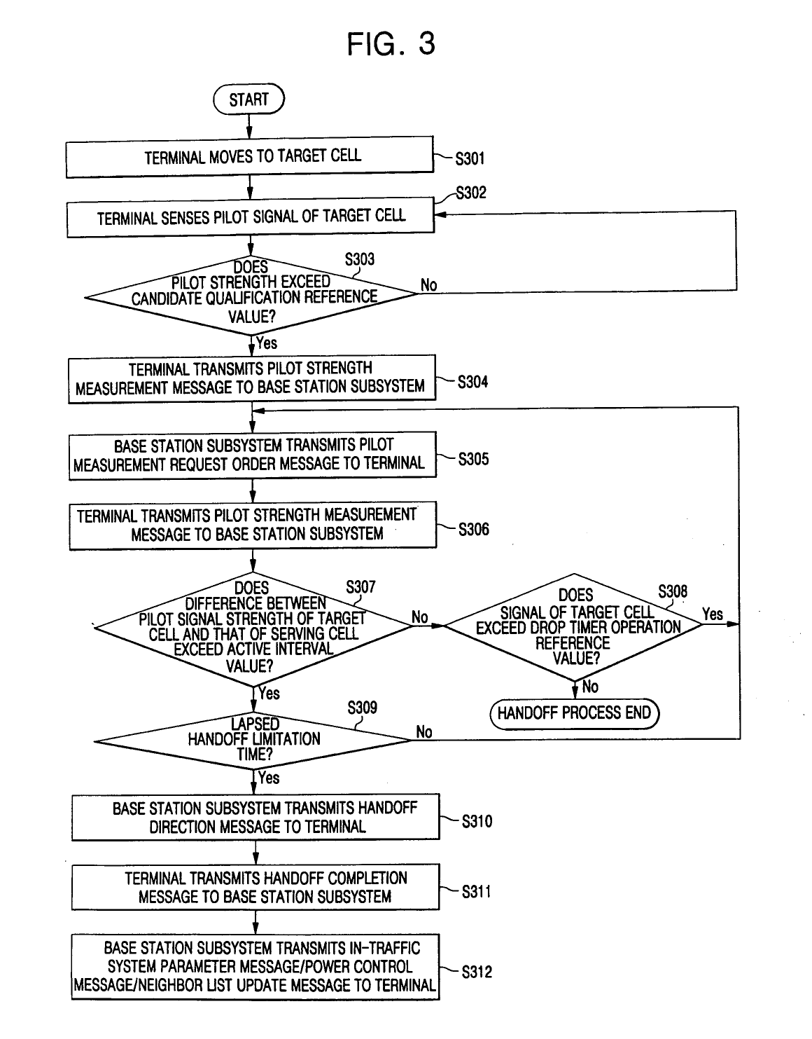

FIG. 3 is a flowchart of an inter-mobile switching center hard handoff process in accordance with an embodiment of the present invention.

It is assumed that the handoff in FIG. 3 is an in-traffic handoff, and one or more hard handoffs were performed so that a handoff restricted time (Guard_Time) is in operation. Further, since a pilot signal as described herein is based on CDMA 2000, if a signal is used as a reference signal, to measure signal strength of a base station like a pilot signal in other mobile communication network, it is considered to be a “pilot signal” in accordance with an embodiment of the present invention.

The mobile terminal 112 of FIG. 2 moves to a target cell (S301), and the mobile terminal 112 senses a pilot signal of a target cell located in a moving direction (S302). In the case that the strength of the pilot signal sensed by the mobile terminal is recognized to exceed a candidate qualification reference value (T_ADD) value (S303), since the first condition for the terminal to report the PSMM is satisfied, the mobile terminal 112 reports the PSMM to the base station (S304). The PSMM is a message to measure the pilot strength received by the base station from the mobile terminal 112. The PSMM includes information such as various pilot signal strengths and phases of a pilot PN received from the corresponding mobile terminal 112.

Here, the candidate qualification reference value is a value of the base transceiver station pilot strength that should be met in order for an adjacent base transceiver station to become a candidate base transceiver station. The candidate qualification reference value is understood as the T_ADD value in the CDMA system, but can be any other value playing the same role in different mobile networks. The same is true of the active interval value and T_COMP, and a drop timer operation reference value and T_DROP, in the CDMA system.

When the base transceiver station receives a pilot strength measurement message of the terminal for sensing a pilot signal whose level is higher than the candidate qualification reference value, a handoff restricted time (about 5 seconds; differs depending on system) is commonly used.

Since the base station does not perform the handoff within the handoff restricted time (Guard_Time) to prevent a ping-pong phenomenon in the hard handoff, even when the active interval value (T_COMP) condition is met, the base station transmits a pilot measurement request order (PMRO) message requesting the terminal to continuously measure and report the pilot strengths (S305).

When the base transceiver station requests a pilot signal list of an adjacent base transceiver station which the mobile terminal recognizes to the mobile terminal 112 through the PMRO, the mobile terminal 112 reports all pilots whose levels are higher than a given threshold value (S306). The message reported to the base station includes a size and a PN phase of each candidate set pilot.

The base station which has received the PSMM should check i) if the condition is met that a difference between a pilot signal strength of the target cell and that of the serving cell exceeds the active interval value (T_COMP), and ii) if the handoff restricted time has lapsed or not.

It is determined whether the difference between the pilot signal strength of the target cell and that of the serving cell exceeds the active interval value (S307), and it is checked if the handoff restricted time has lapsed when the difference exceeds the active interval value (S309). The active interval value (T_COMP) is compared between a difference value between the pilot strength of a candidate group whose base transceiver stations enter into the active set, and the pilot strength of the active set, and a difference value between the strengths of the pilots belonging to the active set.

When the difference value between the pilot signal strength of the target cell and that of the serving cell is less than the active interval value, it is determined again whether the pilot signal strength of the target cell exceeds the drop timer reference value (T_DROP) (S308). Subsequently, the process returns to step 305 where the base station transmits the PMRO to the terminal and repeats the following steps only when the pilot signal strength of the target cell exceeds the drop timer reference value, and the handoff process ends when the pilot signal strength of the target cell drops below the drop timer reference value.

The fact that the difference between the pilot signal strength of the target cell and that of the serving cell exceeds the active interval value (T_COMP) means that a pilot signal of the target cell to which the mobile terminal 112 moves is so strongly received in the terminal that a call control right to the mobile terminal 112 is transferred from the serving cell to the target cell.

That is, the base station checks the handoff restricted time, and periodically transmits a pilot measurement request order (PMRO) to the mobile terminal until the handoff restricted time lapses, thereby requesting information on the strength of the pilot signal contained in the mobile terminal 112.

When the PSMM which meets the active interval value (T_COMP) condition is reported after the handoff restricted time has lapsed, that is, the difference between the Ec/Io of the target cell on the PSMM reported by the mobile terminal 112 and the Ec/Io of the serving cell exceeds the active interval value (T_COMP) value, the base station transmits to the mobile terminal 112 a handoff direction message (HDM) indicating that the handoff to the target cell should be performed, thereby giving a handoff order (S310).

The handoff direction message is a message which the mobile terminal 112 uses to request the handoff from the mobile terminal 112.

The base station does not transmit the PMRO any longer in the case that the PSMM in which the Ec/Io of the target cell is reported below the drop timer operation reference value (T_DROP), in consideration of a load on the mobile terminal 112. Then, in the case that the PSMM is reported, in which the Ec/Io of the target cell exceeds the candidate qualification reference value (T_ADD), the base station resumes the transmission of the PMRO.

The mobile terminal 112 receives the handoff direction message and then transmits the handoff completion message (HCM) indicating that the handoff to the target cell has been completed in order to progress the handoff to the target cell (S311). The base station which has received the handoff completion message transmits an in-traffic system parameter message, a power control message, and a neighbor list update message on a forward traffic channel in order to provide the mobile terminal 112 with new system information based on change of the base transceiver station which controls the mobile terminal 112 (S312).

While a handoff success rate using a conventional inter-mobile switching center hard handoff method was about 80%, the handoff success-rate using the inter-mobile switching center hard handoff in accordance with an embodiment of the present invention was measured to be more than 90%. Judging from the handoff success ratio only, it is considered that the call quality was improved more than 20%.

Embodiments of the present invention have the effect of controlling the handoff mechanism using the pilot measurement request order message in order to prevent the ping-pong phenomenon which occurs in a conventional inter-mobile switching center. Also, an unexpected call loss ratio can be remarkably reduced, and the call quality in the mobile network can be improved.

While the present invention has been described with reference to exemplary embodiments thereof, it will be understood by those skilled in the art that various changes in form and detail may be made therein without departing from the scope of the present invention as defined by the following claims.

What is claimed is:

1. A method for controlling a handoff in a mobile network, comprising:
recognizing, at a terminal, a target cell whose pilot strength is equal to or higher than a candidate qualification reference value and transmitting a pilot strength measurement message to a base station; and
exchanging a pilot measurement request order message and the pilot strength measurement message between the terminal and the base station even within a handoff restricted time and determining whether or not to perform the handoff.

2. The method according to claim 1, wherein the base station does not perform the handoff until the handoff restricted time lapses, even when a difference in pilot signal strength between a serving cell and a target cell exceeds an active interval value.

3. The method according to claim 1, wherein the base station transmits the pilot measurement request order message to the terminal without performing the handoff within the handoff restricted time.

4. The method according to claim 3, wherein the terminal receives the pilot measurement request order from the base station, and transmits the base station with pilot signal information contained therein on a pilot signal whose strength exceeds a predetermined level.

5. The method according to claim 3, wherein the base station stops transmitting the pilot measurement request order message to the terminal when a signal-to-noise ratio of the target cell is equal to or less than a drop timer operation reference value.

6. The method according to claim 5, wherein the base station resumes transmission of the pilot measurement request order message upon receipt of a pilot strength measurement message in which a signal-to-noise ratio of a target cell exceeds the candidate qualification reference value.

7. The method according to claim 1, further comprising transmitting, at the base station, a handoff order to the terminal ordering a handoff to the target cell, when the difference in pilot signal strength between the serving cell and the target cell exceeds the active interval value after the handoff restricted time has lapsed.

8. A system for controlling a handoff in a mobile network, comprising:
a terminal adapted to recognize a target cell whose pilot strength is equal to or higher than a candidate qualification reference value and transmit a pilot strength measurement message over a wireless network in order to attempt a handoff from the serving cell to the target cell; and
a base station for receiving pilot strength information from the terminal and transmitting a pilot measurement request order message to the terminal, thereby determining whether or not an inter-mobile switching center hard handoff has been performed.

9. The system according to claim 8, wherein the base station transmits the pilot measurement request order message to the terminal without performing the handoff within a handoff restricted time, even when it is recognized that a difference in pilot strength between the target cell and the serving cell reported from the terminal exceeds an active interval value.

10. The system according to claim 9, wherein the terminal transmits to the pilot measurement request order message received from the base station with the pilot strength measurement message without performing the handoff within the handoff restricted time.

11. The system according to claim 9, wherein the base station stops transmitting the pilot measurement request order message to the terminal when a signal-to-noise ratio of the target cell is equal to or less than a drop timer operation reference value.

12. The system according to claim 11, wherein the base station resumes transmission of the pilot measurement request order message upon receipt of a pilot strength measurement message in which a signal-to-noise ratio of a target cell exceeds the candidate qualification reference value.

13. A mobile terminal located within a mobile network and performing a hard handoff, wherein the mobile terminal recognizes a target cell whose pilot strength is equal to or higher than a candidate qualification reference value, transmits a pilot strength measurement message to a base station, transmits a pilot strength measurement message responsive to a pilot measurement request order message received from the base station within a handoff restricted time to the base station, and compares a pilot strength of the serving cell with that of the target cell to determine whether or not to perform the handoff.

14. The mobile terminal according to claim 13, wherein the mobile terminal receives the pilot measurement request order message from the base transceiver station and transmits to the base transceiver station the pilot strength measurement message including pilot signal information contained therein on a pilot signal whose strength exceeds a predetermined level.

15. The mobile terminal according to claim 13, wherein in the case of receiving a handoff order from the base station, the mobile terminal performs the handoff to the target cell and transmits to the base station a handoff completion message indicating that the handoff has been completed.
